(19) United States
(12) Patent Application Publication
(10) Pub. No.: US 2023/0110528 A1
(43) Pub. Date: Apr. 13, 2023

(54) DATA ERASING DEVICE AND DATA ERASING METHOD

(71) Applicant: KABUSHIKI KAISHA TOKAI RIKA DENKI SEISAKUSHO, Aichi (JP)

(72) Inventor: Takahiko ANDO, Aichi (JP)

(21) Appl. No.: 17/958,569

(22) Filed: Oct. 3, 2022

(30) Foreign Application Priority Data
Oct. 7, 2021 (JP) 2021-165505

(51) Int. Cl. H04L 9/08

(52) U.S. Cl. CPC H04L 9/0891; H04L 9/0825; H04L 9/0866

(57) ABSTRACT

A data erasing device for use with a key system that allows at least one of an electronic key, a mobile terminal, and an authentication card to be used as a key of an operated subject. The electronic key functions as the key and is verified through wireless communication, the mobile terminal is used as the key by registering a digital key provided from an external device, and the authentication card is verified as the key through proximity wireless communication. A checking unit checks a result of a substitute authentication performed when at least one of the electronic key, the mobile terminal, and the authentication card that is used as the key is lost. The substitute authentication differs from an authentication performed on the lost key. An erasing unit erases key data of the lost key from a memory when the checking unit obtains a checking result indicating successful authentication.

### BACKGROUND

### 1. Field

The following description relates to a data erasing device that erases key data registered to an operated subject and a data erasing method.

### 2. Description of Related Art

A known electronic key registration system allows plural electronic keys to be registered to an onboard electronic control unit (ECU) installed in a vehicle to verify the electronic keys (Japanese Laid-Open Patent Publication No. 2016-188500). Such an electronic key registration system allows a sub-key in addition to a master key to be registered to the onboard ECU.

If a user loses an electronic key, the information about the electronic key should not remain in the onboard ECU for security reasons. The information about the electronic key is erased by, for example, using a dedicated device that is available at a car dealer. Thus, the vehicle needs to go to the car dealer to have the information about the electronic key erased from the onboard ECU. If the vehicle cannot immediately go to the car dealer, a person who finds the lost electronic key may use the vehicle in an unauthorized manner There is a need to cope with such a situation.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One general aspect is a data erasing device for use with a key system that allows at least one of an electronic key, a mobile terminal, and an authentication card to be used as a key of an operated subject. The electronic key mainly functions as the key and is verified through wireless communication, the mobile terminal is used as the key by registering a digital key provided from an external device, and the authentication card is verified as the key through proximity wireless communication. The data erasing device includes a checking unit that checks a result of a substitute authentication performed when at least one of the electronic key, the mobile terminal, and the authentication card that is used as the key is lost, where the substitute authentication differs from an authentication performed on the lost key; and an erasing unit that erases key data of the lost key from a memory when the checking unit obtains a checking result indicating that authentication has been accomplished.

Another general aspect is a data erasing method performed with a data erasing device for use with a key system that allows at least one of an electronic key, a mobile terminal, and an authentication card to be used as a key of an operated subject. The electronic key mainly functions as the key and is verified through wireless communication, the mobile terminal is used as the key by registering a digital key provided from an external device, and the authentication card is verified through proximity wireless communication. The method includes checking a result of a substitute authentication performed, when at least one of the electronic key, the mobile terminal, and the authentication card is lost, with the data erasing device, where the substitute authentication differs from an authentication performed on the lost key; and erasing key data of the lost key from a memory with the data erasing device when obtaining a checking result indicating that authentication has been accomplished.

Other features and aspects will be apparent from the following detailed description, the drawings, and the claims.

### BRIEF DESCRIPTION OF THE DRAWINGS

FIG. 1 is a diagram showing a key system according to one embodiment.

FIG. 2 is a perspective view of a passenger compartment in front of a driver seat.

FIG. 3 is a perspective view of an engine switch.

FIG. 4 is a schematic diagram illustrating a situation in which a key is lost and a different key is used to establish communication with a vehicle.

FIG. 5 is a diagram showing a key data erasing screen.

FIG. 6 is a diagram showing a screen for selecting key data that is to be erased.

FIG. 7 is a diagram showing a screen for performing biometric authentication.

FIG. 8 is a diagram illustrating how key data is erased.

FIG. 9 is a diagram showing a screen for selecting the key data that is to be erased.

FIG. 10 is a diagram illustrating how key data is erased.

FIG. 11 is a schematic diagram of an external server in a modification.

FIG. 12 is a diagram illustrating how key data is erased.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A data erasing device according to one embodiment will now be described.

Structure of Key System 1 (Electronic Key System 4)

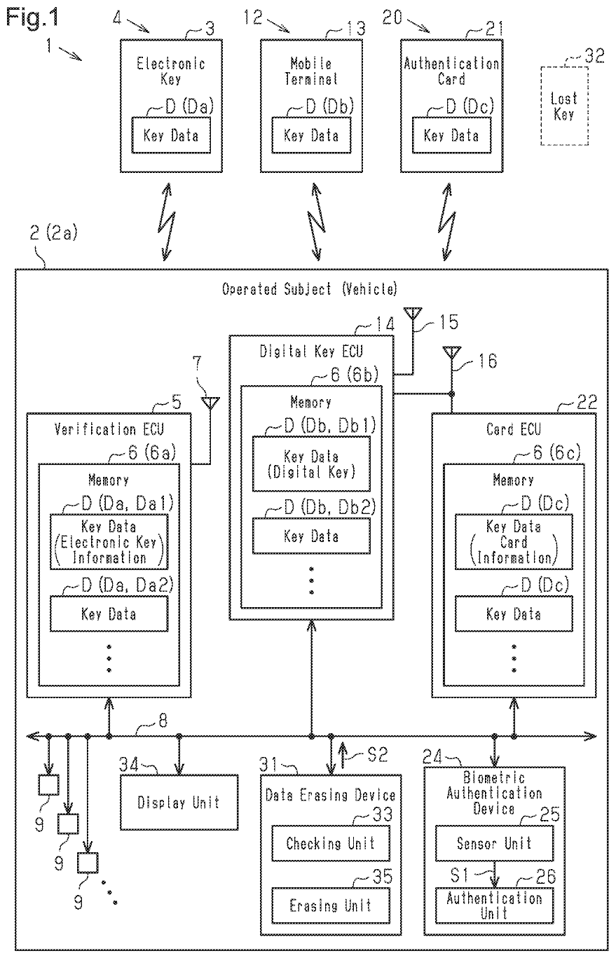

As shown in FIG. 1, a key system 1 includes an electronic key system 4 that authenticates an electronic key 3 and actuates an operated subject 2 through wireless communication. The operated subject 2 is, for example, a vehicle 2a. The electronic key system 4 includes at least one of a smart system that performs authentication in response to communication from the operated subject 2 and a wireless key system that performs authentication in response to communication from the electronic key 3. The wireless communication of the electronic key system 4 may use radio waves in the low frequency (LF) band for communication from the operated subject 2 and radio waves in the ultra-high frequency (UHF) for communication from the electronic key 3.

The electronic key system 4 includes a verification ECU 5 that authenticates the electronic key 3. The verification ECU 5 includes a memory 6 (hereafter referred to as memory 6a) that stores key data D of the electronic key 3 registered to the operated subject 2. The key data D is also stored in the memory (not shown) of the electronic key 3. The key data D of the electronic key 3 serves as electronic key information Da including, for example, an ID code unique to the electronic key 3.

The verification ECU 5 performs wireless communication with the electronic key 3 through a communication unit 7. The communication unit 7 includes, for example, a transmitter that transmits radio waves from the verification ECU 5 and a receiver that receives radio waves from the electronic key 3. The transmitter may transmit radio waves in the LF band. The receiver may receive radio waves in the UHF band. The verification ECU 5 performs wireless communication with the electronic key 3 to authenticate the electronic key 3 by determining whether the key data D is valid.

The verification ECU 5 is connected by a communication line 8 to installed devices 9 in the operated subject 2. Examples of the installed devices 9 include a door lock control device, a steering wheel lock device, an engine control device, and the like. The communication line 8 is, for example, a controller area network (CAN) or a local interconnect network (LIN).

The electronic key 3 includes, for example, a master key and a sub-key. The master key serves as, for example, a main key having functionalities allowing for certain operations to be performed on operated subject 2. In contrast, the functionalities of the sub-key are limited. There may be more than one sub-key.

In the smart system, the verification ECU 5 periodically transmits radio waves in the LF band from the communication unit 7 to find the electronic key 3. When the electronic key 3 receives the radio waves transmitted from the verification ECU 5, the electronic key 3 transmits radio waves in the UHF band in response. When communication is established between the electronic key 3 and the verification ECU 5 in this manner, the electronic key 3 is authenticated by checking whether the valid key data D is registered to the electronic key 3. When the key data D is authenticated, the verification ECU 5 permits actuation of the operated subject 2.

If the operated subject 2 is the vehicle 2a, when the electronic key 3 that is located outside the passenger compartment is authenticated, the verification ECU 5 permits or performs locking or unlocking of the vehicle door. This allows the vehicle door to be locked or unlocked. When the electronic key 3 that is located inside the passenger compartment is authenticated, the verification ECU 5 permits switching of the vehicle power supply. This allows for the engine to be started.

When plural sets of key data D are registered to the memory 6 of the verification ECU 5, the verification ECU 5 sequentially authenticates the sets of key data D. For example, if first electronic key information Da1 and second electronic key information Da2 are registered to the memory 6, when the verification ECU 5 starts authenticating the electronic key 3, the verification ECU 5 first authenticates the first electronic key information Da1. If the first electronic key information Da1 cannot be authenticated, the verification ECU 5 then authenticates the second electronic key information Da2. In this manner, the verification ECU 5 sequentially authenticates the sets of the key data D of the memory 6.

In the wireless key system, when an operation button (not shown) of the electronic key 3 is operated, the electronic key 3 transmits a corresponding action request on radio waves in the UHF band. The action request includes the key data D (electronic key information Da) of the electronic key 3. When receiving the action request from the electronic key 3, the verification ECU 5 authenticates the key data D and allows the operated subject 2 to perform an action that corresponds to the action request. Thus, operation of a lock button of the electronic key 3 locks the vehicle door, and operation of an unlock button of the electronic key 3 unlocks the vehicle door.

Structure of Digital Key System 12

As shown in FIG. 1, the key system 1 includes a digital key system 12 that authenticates a mobile terminal 13 and actuates the operated subject 2 through near-range wireless communication. The digital key system 12 uses the mobile terminal 13 as a key for the operated subject 2. An external device (such as server) registers the key data D to the mobile terminal 13. The mobile terminal 13 is, for example, a multifunction terminal (high-performance mobile phone).

The key data D of the mobile terminal 13 is a digital key db that may be a one-time key, which is used only once or is available for only a fixed period. The key data D may be downloaded to the mobile terminal 13 through various types of methods. For example, the key data D may be downloaded from a server, downloaded through wireless communication with a master key, or downloaded by image-scanning code information. The key data D may be downloaded to the mobile terminal 13 by an external device when the mobile terminal 13 is being manufactured or after the mobile terminal 13 becomes commercially available.

Near-range wireless communication may be a personal area network (PAN) or proximity wireless communication. Examples of the personal area network include Bluetooth® communication, ultra-wide band (UWB) communication, and Wi-Fi® communication. Bluetooth communication may be Bluetooth Low Energy (BLE)®. The proximity wireless communication is, for example, near field communication (NFC), which is one type of RFID.

The digital key system 12 includes a digital key ECU 14 that authenticates the mobile terminal 13. The digital key ECU 14 performs personal area communication using a wireless module 15 and performs proximity wireless communication using a reader-writer 16. The digital key ECU 14 includes a memory 6 (hereafter referred to as memory 6b) storing key data D (digital key db) of the mobile terminal 13 registered to the operated subject 2. Plural sets of key data D (digital key db) may be registered in the same manner as the electronic key system 4. The key data D (digital key db) registered to the digital key ECU 14 does not need to be the information downloaded to the electronic key 3 and may be information obtained by processing (for example, decrypting) the downloaded information.

The digital key ECU 14 periodically transmits an advertisement from the wireless module 15 through near-range wireless communication. The advertisement is periodically transmitted on radio waves to, for example, monitor whether a mobile terminal 13 that can perform near-range wireless communication is located nearby. When the mobile terminal 13 receives an advertisement from the digital key ECU 14, the mobile terminal 13 performs a scanning process and transmits a connection request to the digital key ECU 14. This connects the digital key ECU 14 and the mobile terminal 13 through near-range wireless communication.

When the digital key ECU 41 is connected to the mobile terminal 13 in a manner allowing for communication, the digital key ECU 14 authenticates the mobile terminal 13. The mobile terminal 13 transmits the key data D (digital key db), which is stored in the memory, to the digital key ECU 14 through near-range wireless communication. The digital key ECU 14 receives the key data D from the mobile terminal 13 and authenticates the key data D. When the key data D is correctly decrypted and the key data D is thereby authenticated, the digital key ECU 14 obtains, for example, the valid period of the key data D, a session key used in subsequent near-range wireless communication, the ID of the mobile terminal 13, and the like. Such information is stored as key data D of the digital key ECU 14 in the memory 6b of the digital key ECU 14.

When the key data D is authenticated, the mobile terminal 13 and the digital key ECU 14 are in an authentication completion state in which successful authentication is recognized. In the authentication completion state, the mobile terminal 13 and the digital key ECU 14 have a common session key and acknowledge the ID of the mobile terminal 13. This permits use of the operated subject 2. More specifically, when the operated subject 2 is the vehicle 2a, locking or unlocking of the vehicle door, unlocking of a steering wheel, starting of the engine, and the like are permitted.

Structure of Reader-Writer 16 in One Example

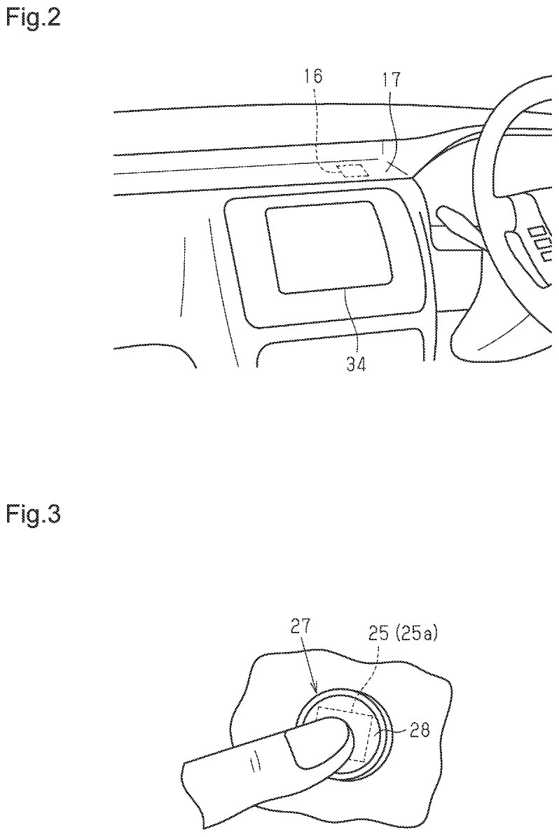

As shown in FIG. 2, the reader-writer 16, when installed in the passenger compartment, may be located on an instrument panel 17 of the driver seat. Examples of other locations where the reader-writer 16 can be arranged include the center console, the center cluster, a side of an engine switch 27, the steering wheel, and the like. The reader-writer 16, when installed outside the passenger compartment, may be located on the glass of the vehicle door, a door mirror, a pillar of the vehicle body, or the like (not shown).

When the battery level of the mobile terminal 13 decreases to an extent that the mobile terminal 13 cannot perform near-range wireless communication, the mobile terminal 13 can be held near the reader-writer 16 to authenticate the mobile terminal 13 through proximity wireless communication. The reader-writer 16 starts transmitting drive radio waves when, for example, the braking pedal is depressed. Preferably, the drive radio waves are, for example, radio waves that power the mobile terminal 13.

When the mobile terminal 13 is held near the reader-writer 16 and drive radio waves are received from the reader-writer 16, the mobile terminal 13 performs proximity wireless communication powered by the radio waves. The digital key ECU 14 authenticates the mobile terminal 13 through proximity wireless communication. When authentication is accomplished, the use of the vehicle 2a, which is the operated subject 2, is permitted. When the operated subject 2 is the vehicle 2a, locking or unlocking of the vehicle door, unlocking of the steering wheel, switching of the power supply (engine starting), and the like are permitted.

Structure of Card Authentication System 20

As shown in FIG. 1, the key system 1 includes a card authentication system 20 that authenticates an authentication card 21 and actuates the operated subject 2 through proximity wireless communication. The authentication card 21 is, for example, a card member (IC card) in which an IC chip is embedded to perform proximity wireless communication. The proximity wireless communication is, for example, near field communication (NFC). The authentication card 21 stores key data D that is unique to the authentication card 21. The key data D of the authentication card 21 serves as card information Dc including, for example, the ID code of the authentication card 21.

The card authentication system 20 includes a card ECU 22 that authenticates the authentication card 21. The card ECU 22 performs proximity wireless communication using the reader-writer 16. The card ECU 22 includes a memory 6 (hereafter referred to as memory 6c) that stores key data D (card information Dc) of the authentication card 21 registered to the operated subject 2. Plural sets of key data D (card information Dc) may be registered in the same manner as the electronic key system 4 and the digital key system 12.

When authenticating the authentication card 21 in the operated subject 2, the authentication card 21 is held near the reader-writer 16. In addition to when the authentication card 21 is authenticated by the user, the authentication card 21 is used in a situation where, for example, the mobile terminal 13 cannot be authenticated due to battery drainage. The authentication card 21 can be activated without a power source. Thus, when the battery of the mobile terminal 13 is drained, the authentication card 21 is authenticated in the operated subject 2.

When the authentication card 21 is held near the reader-writer 16 and drive radio waves are received from the reader-writer 16, the authentication card 21 performs proximity wireless communication powered by the radio waves. The reader-writer 16 may alternately and repeatedly transmit drive radio waves for the mobile terminal 13 and drive radio waves for the authentication card 21. When receiving the corresponding drive radio waves from the reader-writer 16, the authentication card 21 starts proximity wireless communication.

The card ECU 22 receives the key data D (card information Dc) from the activated authentication card 21 and authenticates the authentication card 21. When authentication is accomplished, the use of the vehicle 2a, which is the operated subject 2, is permitted. When the operated subject 2 is the vehicle 2a, locking or unlocking of the vehicle door, unlocking of the steering wheel, switching of the power supply (engine starting), and the like are permitted.

Structure of Biometric Authentication Device 24

As shown in FIG. 1, the operated subject 2 includes a biometric authentication device 24 that performs biometric authentication on the user. Examples of the biometric authentication include fingerprint authentication that uses a fingerprint of the user to authenticate the user and facial authentication (image authentication) that captures a facial image of the user with an image capturing device to authenticate the user with image data. The biometric authentication device 24 includes a sensor unit 25 that detects the physical features of the user and an authentication unit 26 that authenticates biological information S1 output from the sensor unit 25. The operated subject 2 determines the installed device 9 that can be used based on the authentication result of the biometric authentication device 24 in addition to the authentication result of key data D.

As shown in FIG. 3, when biometric authentication is fingerprint authentication, a fingerprint sensor 25a serving as the sensor unit 25 may be arranged in, for example, a switch knob 28 of the engine switch 27 near the driver seat. In this case, when the engine switch 27 is pushed to switch the power supply, the sensor unit 25 obtains biological information S1 (specifically, fingerprint information) at the same time as when the switch operation is performed. The authentication unit 26 performs biometric authentication based on the biological information S1 obtained from the sensor unit 25 to determine whether the user is an authorized user.

When the electronic key 3 is used as the key of the operated subject 2, switching of the power supply (engine starting) is permitted if authentication of the electronic key 3 and authentication of biometric authentication are both accomplished. When the mobile terminal 13 is used as the key of the operated subject 2, switching of the power supply (engine starting) is permitted if authentication of the mobile terminal 13 and authentication of biometric authentication are both accomplished. When the authentication card 21 is used as the key of the operated subject 2, switching of the power supply (engine starting is permitted if authentication of the authentication card 21 and authentication of biometric authentication are both accomplished.

Structure of Data Erasing Device 31

As shown in FIG. 1, the operated subject 2 includes a data erasing device 31 that selectively erases the key data D of a key lost by the user (hereafter referred to as lost key 32). In the present example, the data erasing device 31 is included in the key system 1 that uses at least one of the electronic key 3, the mobile terminal 13, and the authentication card 21 as the key of the operated subject 2. Among the keys, the data erasing device 31 erases the key data D of the lost key 32 from the memory 6.

The data erasing device 31 includes a checking unit 33 that checks the result of a substitute authentication performed when at least one of the electronic key 3, the mobile terminal 13, and the authentication card 21 becomes lost. The substitute authentication differs from the authentication performed on the lost key 32. The checking unit 33 may use, for example, a display unit 34 in the passenger compartment to show instructions on how to perform the substitute authentication and how to erase the key data D of the lost key 32. The substitute authentication may be biometric authentication that performs authentication with biological information S1 obtained from the user. One example of the biometric authentication may be fingerprint authentication using the engine switch 27. The display unit 34 is, for example, a display of a car navigation device.

The data erasing device 31 includes an erasing unit 35 that erases the key data D of the lost key 32 from each memory 6 storing the key data D when the checking unit 33 obtains a checking result indicating successful authentication. When the user specifies the key data D that is to be erased from each memory 6, the erasing unit 35 outputs a data erasing request S2 via the communication line 8 to the verification ECU 5, the digital key ECU 14, and the card ECU 22 so that each memory 6 storing the key data D erases the key data D.

Operation

The operation of the data erasing device 31 according to the present embodiment will now be described.

Case in which Sub-Key of Electronic Key 3 is Lost

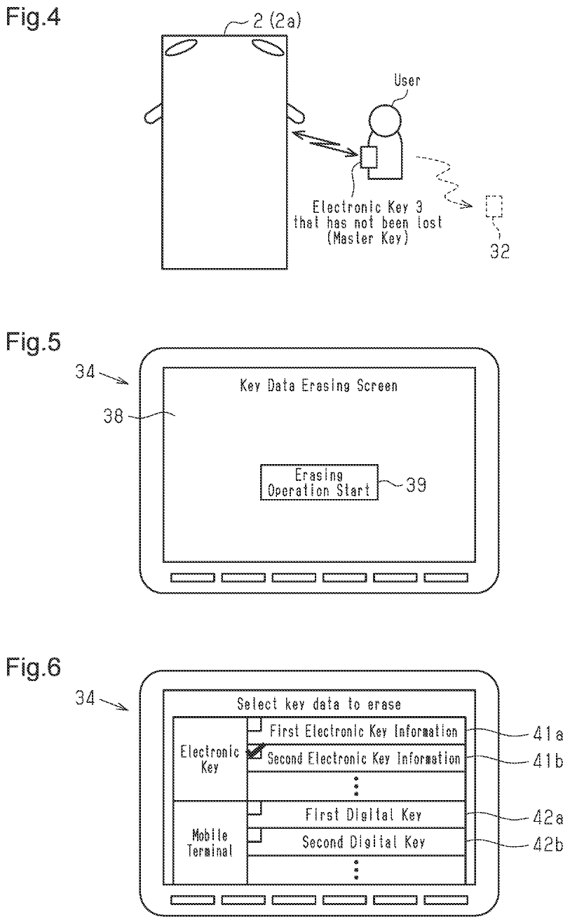

FIG. 4 shows a case in which a key falls out of clothes or a bag and the user loses the key. In this case, the lost key 32 is, for example, a sub-key of the electronic key 3 and the substitute authentication performed by the user to erase the key data D of the sub-key is biometric authentication. Further, the biometric authentication is, for example, fingerprint authentication performed with the fingerprint sensor 25a arranged in the switch knob 28 (knob surface) of the engine switch 27.

First, the user uses a key that has not been lost to accomplish user authentication with the vehicle 2a. In one example, the electronic key 3 that has not been lost is used as a master key. When authentication of the master key is accomplished by the electronic key system 4, the vehicle door is locked or unlocked or allowed to be locked or unlocked. Thus, the user can unlock and open the vehicle door to enter the vehicle.

As shown in FIG. 5, after entering the vehicle 2a, the user uses the display unit 34 in the passenger compartment to erase the key data D. In the present example, the user operates a touch panel on the display unit 34 and selects “Erase Key Data” so that the display unit 34 displays a key data erasing screen 38. Then, the user selects an erasing operation start button 39 displayed in the key data erasing screen 38 to initiate a key data erasing operation.

As shown in FIG. 6, when the user enters the vehicle using the key that has not been lost and erases the key data D, the checking unit 33 uses the display unit 34 in the passenger compartment to instruct the user so that the user can erase the key data D of the lost key 32. In the present example, the display unit 34 displays a list of every set of key data D registered to the memory 6 of the vehicle 2a and has the user select the set of key data D that is to be erased.

In the example shown in FIG. 6, when erasing the key data D of the electronic key 3, the display unit 34 displays a selection column 41a for the first electronic key information Da1 and a selection column 41b for the second electronic key information Da2 as columns for selecting the electronic key information Da that is to be erased. When erasing the key data D of the mobile terminal 13, the display unit 34 displays a selection column 42a for a first digital key Db1 and a selection column 42b for a second digital key Db2 as columns for selecting the digital key db that is to be erased. The user selects the key data D that is to be erased by adding a check to the corresponding one of the selection columns 41a, 41b, 42a, 42b.

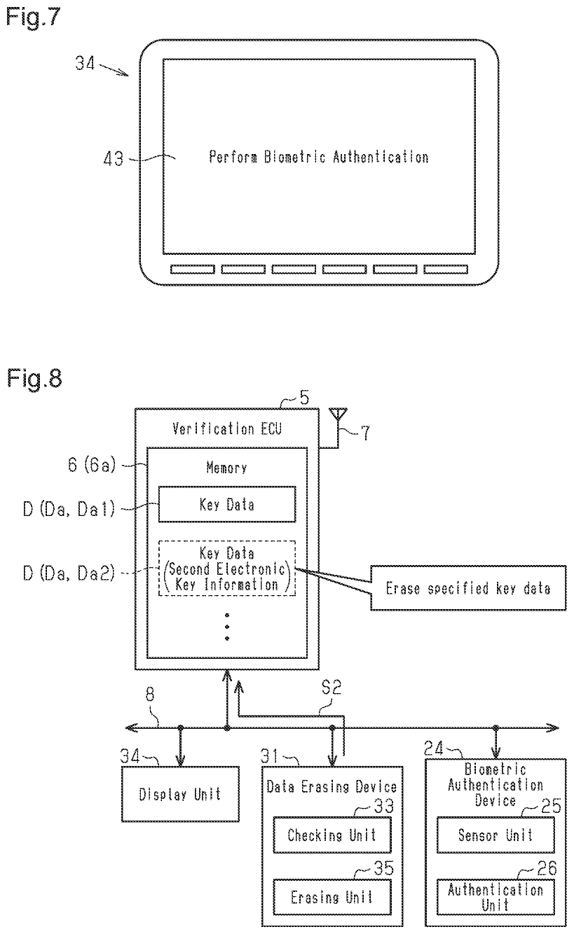

As shown in FIG. 7, after the key data D that is to be erased is selected, the checking unit 33 uses the display unit 34 to instruct the user to perform the substitute authentication in order to erase the key data D. In the present example, the display unit 34 displays a message screen 43 of “Perform Biometric Authentication.” In the case of, for example, fingerprint authentication, a message or image indicating where to place the finger may be shown in the message screen 43.

The biometric authentication device 24 obtains biological information S1 from the user with the fingerprint sensor 25a (sensor unit 25) and authenticates the biological information S1 with the authentication unit 26. The authentication unit 26 compares the biological information S1, which is obtained with the fingerprint sensor 25a, to biological information S1, which is registered in advance, and determines that biometric authentication is accomplished if the two pieces of information match. In this case, the checking unit 33 obtains a checking result indicating that biometric authentication has been accomplished. If the two pieces of biological information S1 do not match, the authentication unit 26 determines that biometric authentication is not accomplished. In this case, the checking unit 33 obtains a checking result indicating that biometric authentication has not been accomplished. In some examples, the authentication unit 26 may determine whether the biological information S1 obtained by the sensor unit 25 corresponds to the biological information S1 registered to the operated subject 2. In some examples, if the biological information S1 obtained by the sensor unit 25 corresponds to the biological information S1 registered to the operated subject 2, the checking unit 33 may obtain a checking result indicating that the authentication unit 26 has accomplished authentication. In some examples, if the biological information S1 obtained by the sensor unit 25 does not correspond to the biological information S1 registered to the operated subject 2, the checking unit 33 may obtain a checking result indicating that the authentication unit 26 has not accomplished authentication.

As shown in FIG. 8, when the checking unit 33 obtains a checking result indicating that biometric authentication has been accomplished, the erasing unit 35 outputs a data erasing request S2 for erasing the key data D specified by the user via the communication line 8 to the one of the verification ECU 5, the digital key ECU 14, and the card ECU 22 storing the key data D. In this case, the second electronic key information Da2 is to be erased and selected. Thus, the data erasing request S2 is sent to the verification ECU 5. The data erasing request S2 includes a command for erasing the second electronic key information Da2 from the memory 6.

When the verification ECU 5 receives the data erasing request S2 from the data erasing device 31, the verification ECU 5 erases the stored key data D from the memory 6 in accordance with the data erasing request S2. Specifically, the verification ECU 5 erases the key data D (second electronic key information Da2 in this case) that is specified by the command of the data erasing request S2. This allows the key data D of the lost key 32 to be erased from the memory 6.

The substitute authentication performed by the user to erase the key data D does not need to be biometric authentication. For example, authentication of an electronic key 3 (for example, a master key) that differs from the lost electronic key 3, authentication of the mobile terminal 13, or authentication of the authentication card 21 may be performed. The substitute authentication may be plural types of authentication performed by the user.

Case in which mobile terminal 13 is lost

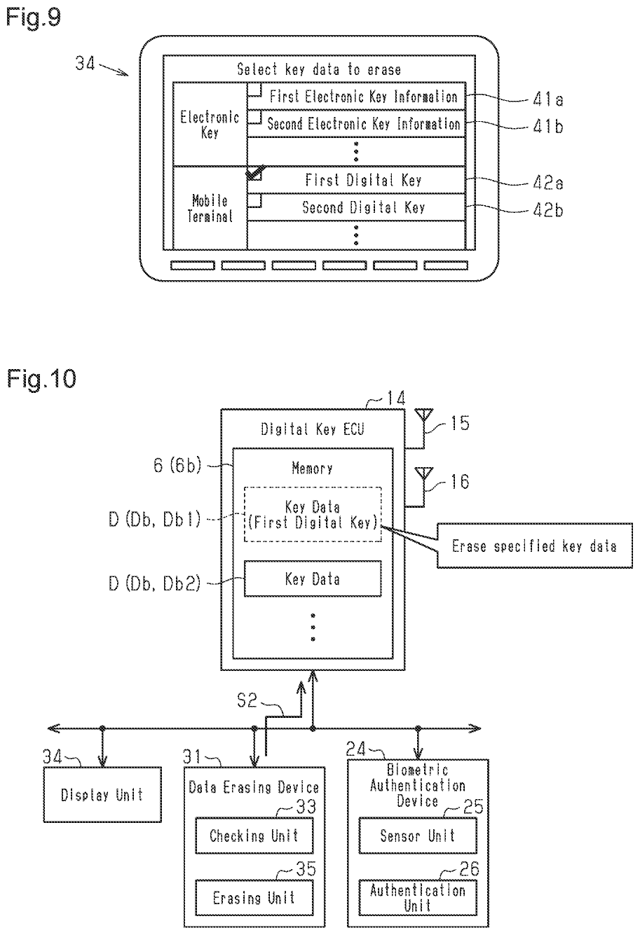

As shown in FIG. 9, the mobile terminal 13 to which the first digital key Db1 is registered may be lost. In this case, the first digital key Db1 is selected and specified from the sets of key data D in a list displayed on the display unit 34. The user performs substitute authentication to erase the first digital key Db1. In this case, as described above, the substitute authentication may be any one of biometric authentication, authentication of the electronic key 3, authentication of a different mobile terminal 13, and authentication of the authentication card 21.

As shown in FIG. 10, when the checking unit 33 obtains a checking result indicating that biometric authentication has been accomplished, the erasing unit 35 outputs a data erasing request S2 for erasing the key data D specified by the user via the communication line 8 to the one of the verification ECU 5, the digital key ECU 14, and the card ECU 22 storing the key data D. In this case, the first digital key Db1 is to be erased and selected. Thus, the data erasing request S2 is sent to the digital key ECU 14. The data erasing request S2 includes a command for erasing the first digital key Db1 from the memory 6.

When the digital key ECU 14 receives the data erasing request S2 from the data erasing device 31, the digital key ECU 14 erases the stored key data D from the memory 6 in accordance with the data erasing request S2. Specifically, the digital key ECU 14 erases the key data D (first digital key Db1 in this case) that is specified by the command of the data erasing request S2. This allows the key data D of the lost key 32 to be erased from the memory 6.

When the authentication card 21 is lost, the key data D of the authentication card 21 is erased through an erasing operation of the key data D of the authentication card 21 through the same procedure as when the electronic key 3 or the mobile terminal 13 is lost, which is described above. Accordingly, the procedure for an erasing operation of the key data D of the authentication card 21 will not be described.

Advantages

The data erasing device 31 (data erasing method) of the above embodiment has the following advantages.

(1) The data erasing device 31 is for use with the key system 1 that allows at least one of the electronic key 3, the mobile terminal 13, and the authentication card 21 to be used as the key of the operated subject 2. The electronic key 3 mainly functions as the key and is verified through wireless communication. The mobile terminal 13 is used as the key by registering a digital key db provided from an external device. The authentication card 21 is verified as the key through proximity wireless communication. When at least one of the electronic key 3, the mobile terminal 13, and the authentication card 21 is lost, authentication differing from that performed with the lost key 32 is performed. The data erasing device 31 includes the checking unit 33 that checks the result of the substitute authentication. The data erasing device 31 includes the erasing unit 35 that erases the key data D of the lost key 32 from the memory 6 when the checking unit 33 obtains a checking result indicating that authentication has been accomplished.

With this structure, when any one of, for example, the electronic key 3, the mobile terminal 13, and the authentication card 21, serving as the key is lost, the user is verified through a substitute authentication that differs from the authentication performed on the lost key 32. When user authentication is accomplished, the key data D of the lost key 32 is erased from the memory 6. This allows the user to directly erase the key data D of the lost key 32 from the memory 6 when the key is lost. This improves security of the operated subject 2 against unauthorized use.

(2) The substitute authentication is biometric authentication based on biological information S1 obtained from the user. This configuration allows for accurate determination of whether the user is authorized though biometric authentication.

(3) The operated subject 2 is the vehicle 2a. When the user enters the vehicle, using a key that has not been lost, to erase the key data D, the checking unit 33 uses the display unit 34 to instruct the user to erase the key data D of the lost key 32. With this configuration, when the key of the vehicle 2a becomes lost, the user erases the key data D of the lost key 32 from the memory 6 by following the instructions shown on the display unit 34, which is arranged in the passenger compartment. This avoids situations where the user does not understand how to erase the key data D of the lost key 32 from the memory 6 and becomes confused.

(4) The checking unit 33 displays a list of every set of key data D registered to the memory 6 on the display unit 34. The erasing unit 35 erases the one of the sets of the key data D selected by the user from the memory 6. In this configuration, the user is presented with every set of key data D registered to the memory 6. Thus, the user can easily find the set of key data D that is to be erased.

Modification

The present embodiment may be modified as follows. The present embodiment and the following modifications can be combined as long as the combined modifications remain technically consistent with each other.

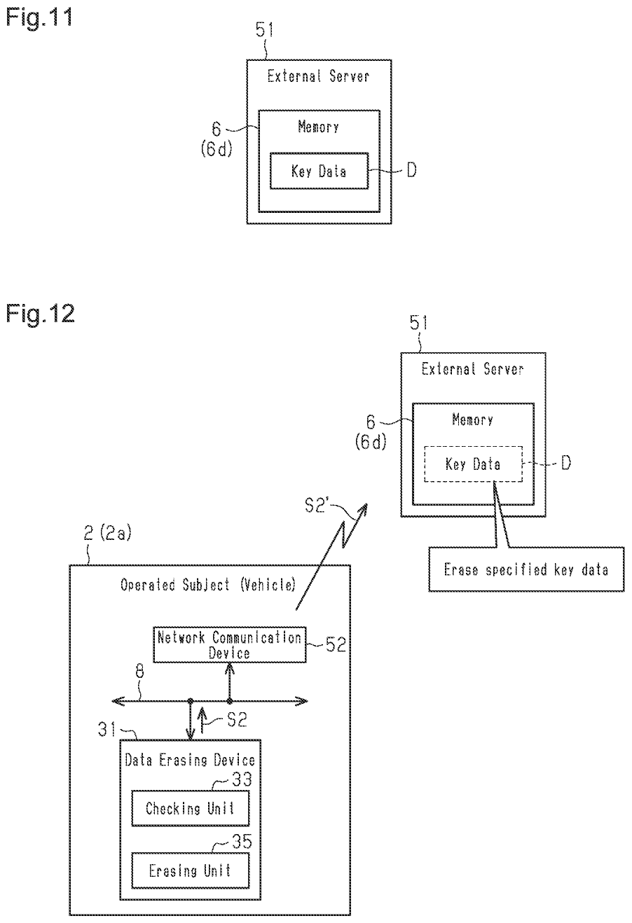

Key data D does not need to be erased from the memory 6 of the operated subject 2 (vehicle 2a). For example, as shown in FIG. 11, when the key data D is stored in the memory 6 (6d) of an external server 51, the key data D may be erased from the memory 6d of the external server 51. The memory 6d of the external server 51 may be, for example, an external memory that manages important information such as personal information.

In this configuration, as shown in FIG. 12, when erasing the key data D from the memory 6d of the external server 51, the erasing unit 35 transmits a data erasing request S2′ from, for example, a network communication device 52 arranged in the operated subject 2. When receiving the data erasing request S2′ from the data erasing device 31, the external server 51 erases the stored key data D from the memory 6d in accordance with the data erasing request S2′. In this manner, the key data D can be erased from the external server 51.

The lost key 32 does not need to be a key that was lost. For example, the lost key 32 may be a key that is no longer used, a key that will not be used, or the like.

The substitute authentication performed by the user to erase key data is not limited to a single authentication and may be two or more types of authentication.

The substitute authentication performed by the user to erase key data does not need to be performed in the passenger compartment and may be performed outside the passenger compartment. In one example, in a state in which the doors of the vehicle 2a are locked, a key data erasing operation is initiated using the window glass of the vehicle door as a display. Then, the user performs a substitute authentication such as biometric authentication. When the authentication is accomplished, key data D specified by the user is erased.

The screen of the mobile terminal 13 may be used as an input interface to erase key data.

The data erasing device 31 may be incorporated into the verification ECU 5, the digital key ECU 14, or the card ECU 22.

The operated subject 2 does not need to be the vehicle 2a and may be replaced by any other apparatus or device.

The checking unit 33 and the erasing unit 35 may be formed by [1] one or more processors operating according to a computer program (software) or [2] a combination of such a processor and one or more dedicated hardware circuits such as application specific integrated circuits (ASIC) that execute at least part of various processes. The processor includes a CPU and memory such as RAM and ROM. The memory stores program code or commands configured to cause the CPU to execute processes. The memory (computer readable media) includes any type of media that are accessible by general-purpose computers and dedicated computers. Instead of a computer including the above processor, processing circuitry formed by one or more dedicated hardware circuits that execute all of various processes may be used.

The checking unit 33 and the erasing unit 35 may be formed by separate processors or processors partially sharing a functionality. In this manner, the checking unit 33 and the erasing unit 35 do not need to be formed by independent function blocks. Instead, the checking unit 33 and the erasing unit 35 may be formed by a single function block or function blocks that are partially shared.

While the present disclosure is described with reference to examples, the present disclosure is not limited to the example or the configuration of the example. The present disclosure includes various variations and modifications within an equivalent range. In addition, various combinations and forms and other combinations and forms, which include only one element or more, shall be within the scope or a range of ideas of the present disclosure.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A data erasing device for use with a key system that allows at least one of an electronic key, a mobile terminal, and an authentication card to be used as a key of an operated subject, wherein the electronic key mainly functions as the key and is verified through wireless communication, the mobile terminal is used as the key by registering a digital key provided from an external device, and the authentication card is verified as the key through proximity wireless communication, the data erasing device comprising:
a checking unit that checks a result of a substitute authentication performed when at least one of the electronic key, the mobile terminal, and the authentication card that is used as the key is lost, wherein the substitute authentication differs from an authentication performed on the lost key; and
an erasing unit that erases key data of the lost key from a memory when the checking unit obtains a checking result indicating that authentication has been accomplished.

2. The data erasing device according to claim 1, wherein the substitute authentication is biometric authentication that performs authentication based on biological information obtained from a user.

3. The data erasing device according to claim 1, wherein
the operated subject is a vehicle, and
when a user enters the vehicle using a key that was not lost and erases the key data, the checking unit uses a display unit arranged in a passenger compartment to show instructions on how to erase the key data of the lost key.

4. The data erasing device according to claim 3, wherein
the checking unit uses the display unit to show a list of every set of the key data registered to the memory, and
the erasing unit erases a selected one of the sets of the key data from the memory.

5. A data erasing method performed with a data erasing device for use with a key system that allows at least one of an electronic key, a mobile terminal, and an authentication card to be used as a key of an operated subject, wherein the electronic key mainly functions as the key and is verified through wireless communication, the mobile terminal is used as the key by registering a digital key provided from an external device, and the authentication card is verified through proximity wireless communication, the method comprising:
checking a result of a substitute authentication performed when at least one of the electronic key, the mobile terminal, and the authentication card is lost with the data erasing device, wherein the substitute authentication differs from an authentication performed on the lost key; and
erasing key data of the lost key from a memory with the data erasing device when obtaining a checking result indicating that authentication has been accomplished.
